(19) United States
(12) Patent Application Publication
(10) Pub. No.: US 2016/0100057 A1
(43) Pub. Date: Apr. 7, 2016

(54) MATCHING INBOUND CALL CENTER CALL TO COMMERCIAL OPPORTUNITY

(71) Applicant: XEROX Corporation, Norwalk, CT (US)

(72) Inventor: Julien Perez, Grenoble (FR)

(21) Appl. No.: 14/504,710

(22) Filed: Oct. 2, 2014

(51) Int. Cl. H04M 3/51; G06Q 30/02; G06F 3/0481

(52) U.S. Cl. CPC H04M 3/5133; G06F 3/0481; G06Q 30/0251

(57) ABSTRACT

Methods and systems conduct a call center communication session (such as a network chat session, video conference, and/or a verbal telephone call) between a user and a call center representative using a specialized call center device (such as a specialized telephone device that provides a call center). These methods and systems use the specialized call center device to automatically identify a topic presented during the call center communication session and to automatically select a commercial opportunity relating to the topic based on previously established relationships between commercial opportunities and topics. Then, these methods and systems use a graphic user interface of the specialized call center device to automatically instruct the call center representative to provide the commercial opportunity to the user before terminating the call center communication session.

### BACKGROUND

Systems and methods herein generally relate to call centers and more particularly to matching inbound calls to a call center with a commercial opportunity presented to the caller.

The use of automation and analytics in the field of consumer care has grown considerably during the last decade. Indeed, the use of intuitive interfaces and methods of automatic feedback gathering in the process of consumer care has been largely adopted in inbound and outbound call centers in order to improve success rate and efficiency of human call agents. In this context, consumer care also represents commercial opportunities that are often underexploited.

### SUMMARY

Exemplary methods herein conduct a call center communication session (such as a network chat session, video conference, and/or a verbal telephone call) between a user and a call center representative using a specialized call center device (such as a specialized telephone device that provides a call center). These methods use the specialized call center device to automatically identify a topic presented during the call center communication session. More specifically, during the call center communication session, the methods herein receive input into the graphic user interface, and such input relates to resolving an issue presented by the user to the call center representative during the call center communication session. The methods herein identify the topic by analyzing the input to select the topic from a plurality of previously established topics.

These methods use the specialized call center device to automatically select a commercial opportunity relating to the topic based on previously established relationships between commercial opportunities and topics. Then, these methods use a graphic user interface of the specialized call center device to automatically instruct the call center representative to provide the commercial opportunity to the user before terminating the call center communication session.

Further, these methods receive feedback from the call center representative before or after the call center communication session is completed, for example, by providing feedback options on the graphic user interface and receiving input from the call center representative into the feedback options. The methods herein revise the relationships between commercial opportunities and topics based on the feedback, for example, by limiting commercial opportunities to specific topics.

Various call center systems herein include, among other components, a specialized call center device, and a graphic user interface operatively connected to the specialized call center device. The specialized call center device processes a call center communication session between a user and a call center representative.

The specialized call center device automatically identifies a topic presented during the call center communication session. More specifically, the graphic user interface receives input during the call center communication session, and such input relates to resolving an issue presented by the user to the call center representative during the call center communication session. The specialized call center device identifies a topic by analyzing the input to select the topic from a plurality of previously established topics.

The specialized call center device automatically selects a commercial opportunity relating to the topic based on previously established relationships between commercial opportunities and topics. The graphic user interface automatically instructs the call center representative to provide the commercial opportunity to the user before terminating the call center communication session.

The specialized call center device receives feedback from the call center representative after the call center communication session is completed and revises the relationships between commercial opportunities and topics based on the feedback (e.g., by limiting commercial opportunities to specific topics). More specifically, the graphic user interface provides feedback options on the graphic user interface and receives input from the call center representative into the feedback options.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a flow diagram of various methods herein;

FIG. 2 is a flow diagram of various methods herein;

FIG. 3 is a schematic diagram illustrating systems herein;

FIG. 4 is a schematic diagram illustrating devices herein; and

FIG. 5 is a schematic diagram illustrating a graphic user interface herein.

### DETAILED DESCRIPTION

As mentioned above, consumer care also represents commercial opportunities that are often underexploited. In fact, an inbound consumer call can often be transformed to a commercial lead if a call center agent performs the correct proposition at the right time of the conversation. In view of this, the systems and methods herein assist human agents in call centers to perform pertinent commercial propositions during inbound calls. The systems and methods herein address many questions, including: (1) recognizing the adequate calls for commercial proposition; (2) defining a commercial opportunity; and (3) defining a method to automatically find the most appropriate subset of available propositions to make to a consumer by the call center agent based on the information that is gathered during the actual call. Finally, a loop back method is provided in order to reinforce the best opportunities at the scale of the overall call-center.

Consumer care is commonly related to a set of question types that call center agents are supposed to answer as quickly as possible, with the highest success rate. The success rate is commonly measured by the client satisfaction with respect to the question asked. Related to technological products, these questions are commonly device specification questions, “how to” questions, transactional requests, and troubleshooting requests. First, device specification questions concern the need of information of products supported by the call center, for example “what is the battery capacity of a specific phone?” Second, “how to” questions are related to the usage of a product supported by the call center, for example “How do I set up my e-mail account in my phone?” Third, the transactional questions are mainly linked to products and services purchases requested that the call center can handle, for example “could you please change my phone contract and my insurance policy to these new ones.” Finally, troubleshooting questions are related to situations where the consumer experiences a technical problem with its product and needs an interactive assistance in order to fix it, for example “my phone does not send text messages anymore, what should I do?” For all these situations, a call center agent relies on a knowledge base accessed through an interface, and also sometimes the web, to find the correct answers to each of these problems.

With systems and methods herein, an inbound consumer call can often be converted to a commercial lead because the systems and methods herein cause the call center agent to perform the correct proposition at the right time of the conversation. The systems and methods herein provide an automatic opportunity matcher to help the consumer care agents propose commercial opportunities to clients during an inbound call. One challenge is to define a commercial opportunity. Another is to define a feedback information retrieval process that matches consumer call situations and commercial opportunities that can be exposed to the call center agent interface.

The systems and methods herein provide a feedback information retrieval system of commercial opportunity matching for consumer care dialogs. The autonomic commercial opportunity matching processes that is provided by the systems and methods herein finds, during the inbound call of a client to the consumer care service, pertinent commercial opportunities with respect to its initial request. These opportunities are initially defined in order to assist the consumer care agent to maximize the commercial potential of each consumer call.

The sample conversation below provides an example of a device specification question in the mobile phone domain, and the last utterance of the call center agent is a commercial opportunity proposition (in the simplest case of device specification questions, such situation can often be considered as a pre-acquisition type of consumer action).

Agent: Hello, how can I help you today?

Customer: Hi, I wanted to know which phone has the widest screen between phone X and phone Y.

Agent: Phone Y has actually the widest screen with a dimension of 4-inch (diagonal).

Agent: However, because the screen size seems to matter to you, we actually propose an exclusive sale for the new Phone Z!

In the above conversation, information is provided to the customer in order to motivate a buying act. In the case of transactional questions, commercial opportunities like customization or providing accessories are often possible. Indeed, such cases are often related to a buying situation initiated by a customer. The following is an example of a troubleshooting type of dialog in the mobile phone domain, and the last utterance of the call center agent is a commercial opportunity proposition.

Agent: Hello, how can I help you today?

Customer: Hi, I just broke the screen of my phone.

Agent: I'm sorry for that, let me guide you through the procedure of return to the after sale service.

Agent: By the way, you could be interested in subscribing to a premium customer care service. By doing so, you could obtain a replacement phone during the repair period that is estimated at two weeks actually.

The following is an example conversation relating to a “how to” type of dialog in the mobile phone domain, and again the last utterance of the call center agent is a commercial opportunity proposition.

Agent: Hello, how can I help you today?

Customer: Hi, I need to know how to configure my video account on my new phone.

Agent: Of course, let me guide you through this procedure.

Agent: By the way, it seems that your mobile phone account does not include a large access to our data network. It could be more adapted for your mobile video streaming experience to consider a larger bandwith 4G access mobile account.

One challenge with the foregoing is the ability to find, in the short time frame of a consumer call, the best opportunities to expose to the consumer. Indeed, it can be particularly challenging for a human consumer care agent to remember a potentially large set of diverse commercial opportunities related to a given consumer care situation. A second challenge is the ability to estimate the probability of success of a given opportunity with respect to the current consumer care situation. The systems and methods herein display, in real time, in the consumer care agent interface, a list of commercial opportunities that the agent will choose to suggest during the call.

Several call situations, such as device specification questions or transactional questions, are especially adequate to such propositions. The systems and methods herein provide a commercial opportunity using different elements. First, a set of structured information related to a service or a product is provided to a customer care representative, and the customer care representative is instructed to suggest such a product or service to a consumer during the call. This information can include a category of product or service, and text describing the item. Secondly, a set of conditions relating to the current consumer care dialog situation is specified in order to prevent certain opportunities from being provided, to increase the likelihood of only providing opportunities that the customer will find attractive. The second kind of constraint is, for example, that only a particular type of call should be eligible for the corresponding proposition, or to limit propositions to calls concerning a particular device. Finally, explicit constraints are provided to present a “limited time” kind of special offer. The opportunities can be defined by, for example, the corporate client operating or sponsoring the call center.

With respect the feedback used for proposition matching, a vectorized representation of the current situation of the calls and the corresponding commercial opportunities are defined in advance (e.g., by the corporate client operating or sponsoring the call center) in order to perform information retrieval and to assess the probability of success of a given commercial opportunity presentation in real time for a consumer care call.

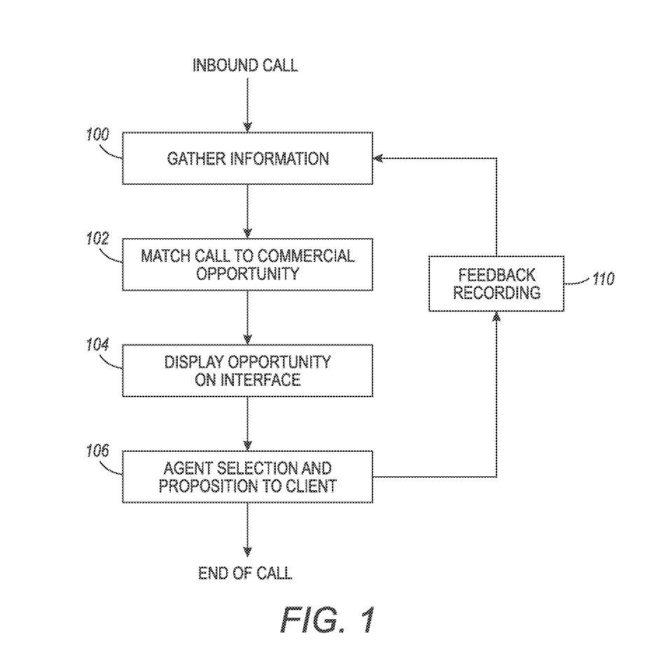

FIG. 1 is one flowchart representation of such a feedback loop used in the overall processing of matching an inbound call to a commercial opportunity. Beforehand, all commercial opportunities are vectorized by (1) a set of features representing the Bag of Word (BoW) of its description and (2) a set of strict match conditions also expressed as a set of features, for example the device type, the information related to the client, the time lapse, etc. This vectorized description set of commercial opportunities is assumed to be available for all concerned agents.

As shown in FIG. 1, after a call is received, in item 100 information gathering is performed. During the information gathering process in item 100, the interface, used by the call center agent, automatically accumulates information about the current call while the agent performs searches and actions for the customer. That information is related to (1) the user's identity and account specification, (2) the device or service that is the subject of the call and (3) the BoW of the search queries performed by the call center agent during the call on its interface in order to answer the client requests.

The information gathering process in item 100 is performed accordingly to the type of interaction between the call center agent and the client. On one hand, in the context of a text based assistance scenario, the overall conversation will be available for information extraction. On another hand, in the context of a voice call, the information gathering process will be based on information searched by the call center agent.

During the call, matches are made to commercial opportunities in item 102. Thus, in item 102, the systems and methods herein use the set of information gathered in item 100, to perform a search, as a background task, during the agent-client conversation, in order to present the most pertinent commercial opportunities to propose to the consumer with respect to the current state of the dialog.

Then, in item 104, these propositions are presented/displayed in a facet of the call center agent interface. The system offers the possibility to the consumer care agent to address the most adequate commercial opportunities when the agent estimates it is appropriate in the context of the call, as shown by item 106, which illustrates the agent selection and proposition to the client.

Finally, to assess the potential success of an opportunity, the call center agent is asked to supply feedback 110 through the interface (e.g., by clicking a button displayed in the interface) to inform the systems and methods herein that a given commercial opportunity has been provided to the consumer and has led to a success, or not. This is the feedback recording process shown as item 110 and the associated feedback loop. Such a feedback procedure 110 allows each commercial opportunity presentation to consumers to be automatically tracked and then ranked for the overall call center. A variety of different methods can be used to find such a ranking function. In one example, the ranking function could be:

$$R ( d , {o}_{i} , {c}_{i} ) = \frac{{e}^{{φ ( d , o \_i )}^{T}} θ}{{\sum }_{j = 1}^{k} {e}^{{φ ( d , o\_ j )}^{T}} θ} \times ϕ ( d , {c}_{i} )$$

Where d ∈ [symbol] ^{N} is the vectorized representation of the current customer dialog situation, oᵢ ∈ [symbol] ^{M} the i-th commercial opportunity available in the system and θ a vector of parameters that will be adapted using stochastic gradient descent type of processes over the success feedback given by the agent. Then, φ: [symbol] ^{N+M}→{0,1} models the set of constraints cᵢ, associated to the commercial opportunity oᵢ, that can be empty, that the dialog is supposed to verify in order to be displayed in the rank list of opportunities displayed in the consumer care software interface. If a constraint of cᵢ, is not verified for a dialog d, φ(d, cᵢ)=0 and soR(d, oᵢ, cᵢ). An advantage of such a function is the capability to seamlessly integrate the feedback of the call center agent by optimizing the θ parameter. Finally, in order to ensure an exploitation-exploration tradeoff between the available opportunities and the current state of knowledge of the system, the commercial opportunities can be selected.

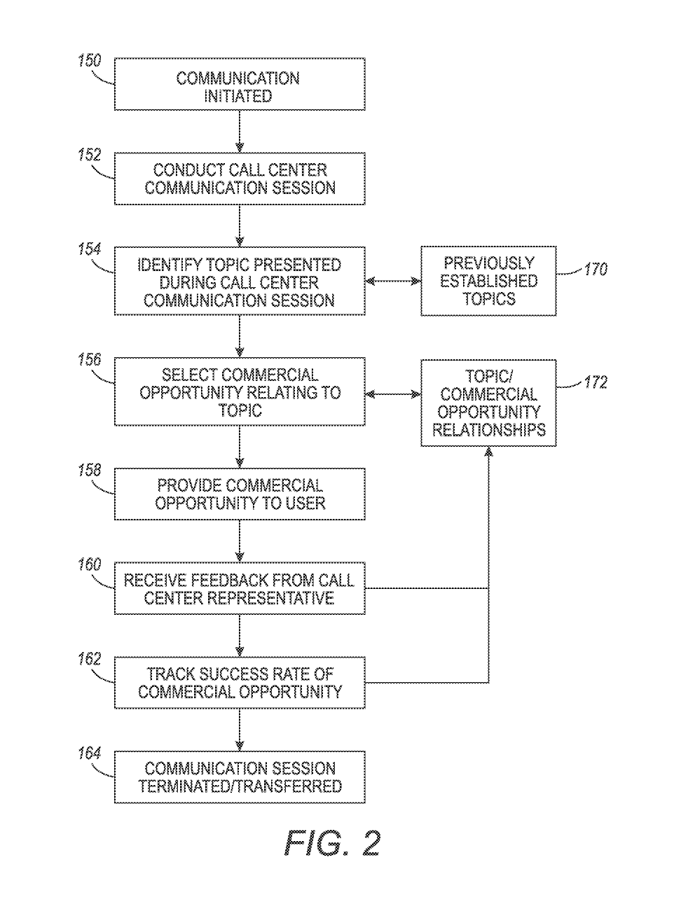

FIG. 2 is another flowchart illustrating exemplary methods herein. In item 150, some form of communication session is initiated, either by a user contacting a call center for assistance, a call center representative initiating or returning a communication request, or any other communication established in any way. Therefore, in item 152, these methods conduct a call center communication session (such as a network chat session, video conference, and/or a verbal telephone call) between a user and a call center representative using a specialized call center device (such as a specialized telephone device that provides a call center). Further, the call center representative can be a human or non-human entity (such as an animated character whose words, gestures, and actions our automatically controlled by a computerized device).

In item 154, these methods use the specialized call center device to automatically identify a topic presented during the call center communication session. More specifically, in item 154, during the call center communication session, the methods herein receive input into the graphic user interface, and such input relates to resolving an issue presented by the user to the call center representative during the call center communication session.

Thus, the methods herein identify the topic by analyzing any available input to select the topic from a plurality of previously established topics 170. The previously established topics 170 can be manually and/or automatically created and updated. For example, automated learning processes can supplement a previously created list of topics by automatically identifying new topics to add to the list of topics based upon what is currently being discussed in call center communications. Additionally, the list of topics 170 can be edited by the corporate client that owns or sponsors the call center, in order to focus the commercial opportunities being presented in a specific direction.

More specifically, the input used to identify the topic in item 154 can come from any source available. For example, if the communications session is in an electronic-type format (chat session, e-mail communication, automated character conversation, etc.) all the words and phrases used by all parties to the communication session can be analyzed to identify one or more topics of the session. Similarly, if the communication session is verbal with a human call center representative, the methods herein can simply look to the typed input the call center representative provides into the graphic user interface when attempting to answer the caller's issue; or, voice recognition technology can be utilized to track the words and phrases being discussed during the verbal communication session, and all such words and phrases can be analyzed to help identify the topic(s).

In item 156, these methods use the specialized call center device to automatically select a commercial opportunity (e.g., advertisement, product offer, service offer, contract offer, etc.) relating to the topic of the session based on previously established relationships between commercial opportunities and topics 172. The topics/commercial opportunity relationships 172 also can be manually and/or automatically created and updated. For example, automated learning processes can supplement a previously created set of relationships by automatically identifying new relationships based upon new commercial opportunities, new products, success rates of commercial opportunities, etc. Additionally, the corporate client that owns or sponsors the call center can specifically manipulate the topics/commercial opportunity relationships 172 to achieve specific marketing goals.

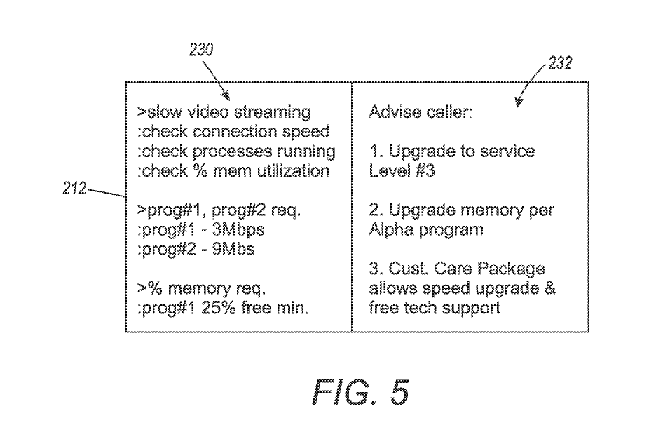

Then, in item 158, these methods use a graphic user interface of the specialized call center device to automatically instruct the call center representative to provide the commercial opportunity to the user before terminating the call center communication session. In item 158, many different commercial opportunities can be displayed to the call center representative to allow the call center representative to use their own discretion to choose the one or more most appropriate commercial opportunities to present to the caller. In one example of item 158, the graphic user interface can include a dedicated portion of the screen that lists one or more possible commercial opportunities that can be provided to the caller, or such can be provided in pop-up menus, etc., as shown in FIG. 5.

Alternatively, in item 158, if the call center representative is an automated character, these methods insert the commercial opportunity into the automated character's automated conversation. Similarly, if the communication session is text-based (chat session, e-mail session, etc.) the commercial opportunities in item 158 can be automatically included with the text-based responses provided to the consumer (without any action being taken by the call center representative).

As noted above, the commercial opportunities supplied to the call center representative through the graphic user interface can present many different marketing messages/reminders from which the call center representative can choose, depending upon the tenor of the call, the caller's attitude, additional information gleaned by the call center representative, etc. Therefore, the commercial opportunities presented in item 158 are not mere instructions to the call representative, but instead can include guidance, suggestions, reminders, etc., that are provided in order to help the call center representative achieve the dual purpose of resolving the caller's issue and, at the same time, promoting the call center owner's/sponsor's marketing goals. Therefore, the term “commercial opportunity” is used generically herein to mean instructions to inform the caller about products and services offered by the owner or sponsor of the call center, as well as guidance, suggestions, reminders about such products and services.

In item 160, either during the communication session or afterwards, these methods receive feedback from the call center representative, for example, by providing feedback options on the graphic user interface and receiving input from the call center representative into the feedback options. Thus, in item 160, the call center representative can indicate which commercial opportunity(s) were provided to the caller and potentially the caller's reaction.

In addition, in item 162, the methods herein can automatically track the success rate of the commercial opportunities. This information can be provided by the call center representative (by the call center representatives indicating that the caller accepted or declined a specific offer) or the success rate can be tracked by uniquely identifying the caller (e-mail, phone number, online personality, account number, etc.) and then recording whether that caller eventually utilizes the product or service offered during the communication session. The information obtained in items 160 and 162 is then fed back to the learning algorithms within the topics/commercial opportunity relationships 172 to help refine the relationships 172, by identifying which commercial opportunities were most successful, which commercial opportunities were presented to callers by the call center representatives for given topics, which topics/advertisements where the most popular among call center representatives, etc. The methods herein revise the relationships between commercial opportunities and topics based on the feedback, for example, by limiting certain commercial opportunities to specific topics.

Item 164 represents the termination or transfer of the communication session, which can occur at any time after item 158. Some communication sessions may go on for long periods of time (days, weeks, etc.) depending upon the format of communication utilized, and other communication sessions may result in the caller being transferred to a sales department if, for example, the caller accepts an offer presented by the call center representative, which needs to be processed by a specific sales department.

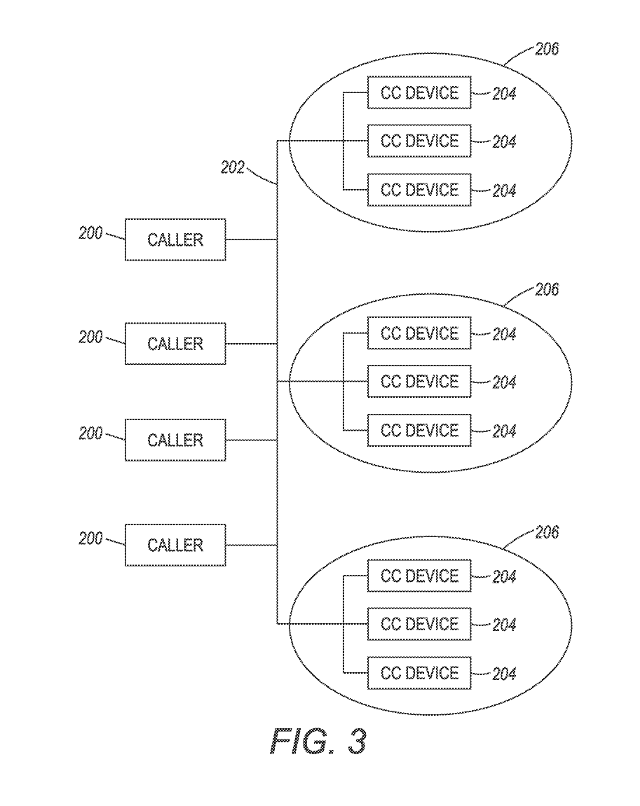

As shown in FIG. 3, exemplary systems herein include various specialized call center devices 204 (CC device) located at various different physical locations 206. The specialized call center devices 204 can include telephone equipment, special-purpose computerized devices, special-purpose switching equipment, etc., and are in communication (operatively connected to one another) with each other and with callers 200 by way of a local or wide area (wired or wireless) network 202.

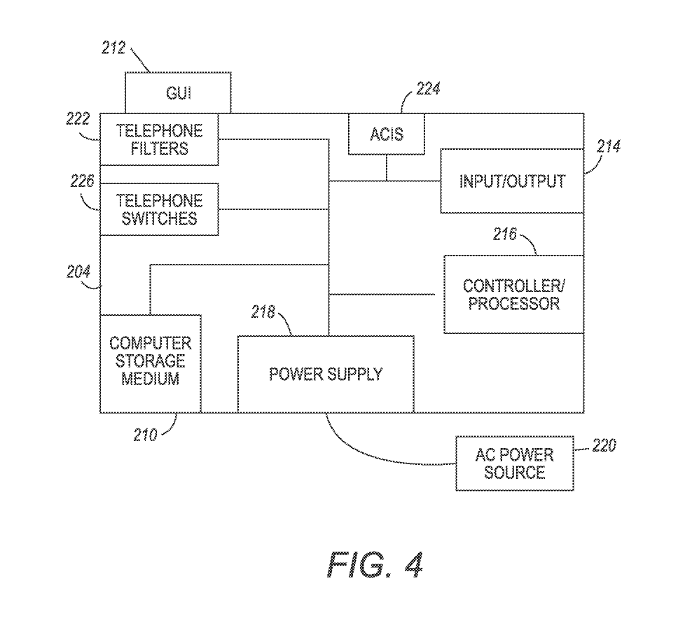

FIG. 4 illustrates one exemplary specialized call center device 204, which can be used with systems and methods herein, and such device can comprise a computerized server, a computerized terminal, telephone switching gear, etc. The specialized call center device 204 includes a controller/tangible processor 216 and a communications port (input/output) 214 operatively connected to the tangible processor 216 and to the computerized network 202 external to the specialized call center device 204. Also, the specialized call center device 204 can include at least one accessory functional component, such as a graphical user interface (GUI) assembly, handsets, headsets, etc., 212. The call center representative may receive messages, instructions, and menu options from, and enter instructions through, the graphical user interface or control panel 212.

The input/output device 214 is used for communications to and from the specialized call center device 204 and comprises a wired device or wireless device (of any form, whether currently known or developed in the future). The tangible processor 216 controls the various actions of the computerized device and can include specialized circuitry, memory, buffers, filters, sound processors, etc., that are specialized for processing verbal telephone calls, chat sessions, etc., and that distinguish the tangible processor 216 from a general-purpose processor.

Further, the specialized call center device 204 can include specialized telephone filters 222 and telephone switching equipment 226, along with application specific integrated circuits (ASIC's) comprising hardware logic circuits that are specialized for processing verbal telephone calls, chat sessions, etc., and such devices distinguish the specialized call center device 204 from general-purpose computerized devices, such as general purpose personal computer, and general purpose servers.

A non-transitory, tangible, computer storage medium device 210 (which can be optical, magnetic, capacitor based, etc., and is different from a transitory signal) is readable by the tangible processor 216 and stores instructions that the tangible processor 216 executes to allow the computerized device to perform its various functions, such as those described herein. Thus, as shown in FIG. 4, a body housing has one or more functional components that operate on power supplied from an alternating current (AC) source 220 by the power supply 218. The power supply 218 can comprise a common power conversion unit, power storage element (e.g., a battery, etc), etc.

Thus, various call center systems herein include, among other components, a specialized call center device 204, and a graphic user interface 212 operatively connected to the specialized call center device 204. The specialized call center device 204 processes a call center communication session between a user and a call center representative.

The specialized call center device 204 automatically identifies a topic presented during the call center communication session. More specifically, the graphic user interface 212 receives input during the call center communication session, and such input relates to resolving an issue presented by the user to the call center representative during the call center communication session. The specialized call center device 204 identifies a topic by analyzing the input to select the topic from a plurality of previously established topics.

The specialized call center device 204 automatically selects a commercial opportunity relating to the topic based on previously established relationships between commercial opportunities and topics. The graphic user interface 212 automatically instructing the call center representative to provide the commercial opportunity to the user before terminating the call center communication session.

The specialized call center device 204 receives feedback from the call center representative after the call center communication session is completed and revises the relationships between commercial opportunities and topics based on the feedback (e.g., by limiting commercial opportunities to specific topics). More specifically, the graphic user interface 212 provides feedback options on the graphic user interface 212 and receives input from the call center representative into the feedback options.

As would be understood by those ordinarily skilled in the art, the specialized call center device 204 shown in FIG. 4 is only one example and the systems and methods herein are equally applicable to other types of specialized call center devices that may include fewer components or more components.

FIG. 5 provides a schematic diagram of one screen that could be presented to the call center representative through the graphic user interface 212. In this example, the left side 230 of the graphic user interface 212 shows queries (>) entered by the call center representative and responses (:) to such queries, forming a thread of queries/responses from which item 154 identifies one or more topics of the communication session, as discussed above. The right side 232 of the graphic user interface 212 illustrates some exemplary commercial opportunity suggestions automatically generated by the processing shown in FIGS. 1 and 2 that relate to the topics the systems and methods herein identified from words in area 230. Specifically, in this example, the topics of “video streaming” and “speed” have been related to specific programs (service level #3, Alpha program, a customer care package, etc., in area 232) that the call center representative could present to the caller.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

1. A method comprising:
conducting a call center communication session between a user and a human call center representative using a specialized call center device providing a call center;
receiving input into a graphic user interface of said specialized call center device from said human call center representative during said call center communication session, said input relating to an interactive dialogue of questions and answers between said human call center representative and said user during said call center communication session for resolving an issue presented by said user to said human call center representative, said interactive dialogue of questions and answers occurring after said issue is presented by said user;
automatically, by said specialized call center device, identifying a topic presented during said call center communication session, said indentifying a topic comrpising analyzing said input to select said topic from a plurality of previously established topics;
automatically, by said specialized call center device, selecting a commercial opportunity relating to said topic based on previously established relationships between commercial opportunities and topics;
automatically, using a graphic user interface of said specialized call center device, instructing said human call center representative to provide said commercial opportunity to said user at a time within said call center communication session when said interactive dialogue of questions and answers indicates that a call situation matches said topic to said commercial opportunity and before terminating said call center communication session;
receiving feedback from said human call center representative after said call center communication session is completed; and
revising said previously established relationships between commercial opportunities and topics based on said feedback.

2-3. (canceled)

4. The method according to claim 1, said receiving feedback comprising:
providing feedback options on said graphic user interface; and
receiving input from said human call center representative into said feedback options.

5. The method according to claim 1, said revising said previously established relationships comprising limiting commercial opportunities to specific topics.

6. A method comprising:
conducting a verbal telephone call between a user and a human call center representative using a specialized telephone device providing a call center;
receiving input into a graphic user interface of said specialized telephone device from said human call center representative during said verbal telephone call, said input relating to an interactive dialogue of questions and answers between said human call center representative and said user during said call center communication session for resolving an issue presented by said user to said human call center representative, said interactive dialogue of questions and answers occurring after said issue is presented by said user;
automatically, by said specialized telephone device, identifying a topic presented during said verbal telephone call, said identifying a topic comprising analyzing said input to select said topic from a plurality of previously established topics;
automatically, by said specialized telephone device, selecting a commercial opportunity relating to said topic based on previously established relationships between commercial opportunities and topics;
automatically, using a graphic user interface of said specialized telephone device, instructing said human call center representative to verbally provide said commercial opportunity to said user at a time within said call center communication session when said interactive dialogue of questions and answers indicates that a call situation matches said topic to said commercial opportunity and before terminating said verbal telephone call;
receiving feedback from said human call center representative after said call center communication session is completed; and
revising said previously established relationships between commercial opportunities and topics based on said feedback.

7-8. (canceled)

9. The method according to claim 6, said receiving feedback comprising:
providing feedback options on said graphic user interface; and
receiving input from said human call center representative into said feedback options.

10. The method according to claim 6, said revising said previously established relationships comprising limiting commercial opportunities to specific topics.

11. A call center system comprising:
a specialized call center device; and
a graphic user interface operatively connected to said specialized call center device,
said specialized call center device processing a call center communication session between a user and a human call center representative,
said graphic user interface receiving input from said human call center representative device during said call center communication session, said input relating to an interactive dialogue of questions and answers between said human call center representative and said user during said call center communication session for resolving an issue presented by said user to said human call center representative, said interactive dialogue of questions and answers occurring after said issue is presented by said user;
said specialized call center device automatically identifying a topic presented during said call center communication session, said identifying a topic comprising analyzing said input to select said topic from a plurality of previously established topics,
said specialized call center device automatically selecting a commercial opportunity relating to said topic based on previously established relationships between commercial opportunities and topics,
said graphic user interface automatically instructing said human call center representative to provide said commercial opportunity to said user at a time within said call center communication session when said interactive dialogue of questions and answers indicates that a call situation matches said topic to said commercial opportunity and before terminating said call center communication session,
said graphic user interface receiving feedback from said human call center representative after said call center communication session is completed, and
said specialized call center device revising said previously established relationships between commercial opportunities and topics based on said feedback.

12-13. (canceled)

14. The call center system according to claim 11, said graphic user interface:
providing feedback options on said graphic user interface; and
receiving input from said human call center representative into said feedback options.

15. The call center system according to claim 11, said specialized call center device revising said previously established relationships by limiting commercial opportunities to specific topics.

16. A call center system comprising:
a specialized telephone device; and
a graphic user interface operatively connected to said specialized telephone device,
said specialized telephone device processing a verbal telephone call between a user and a human call center representative,
said graphic user interface receiving input from said human call center representative during said verbal telephone call, said input relating to an interactive dialogue of questions and answers between said human call center representative and said user during said verbal telephone call for resolving an issue presented by said user to said human call center representative, said interactive dialogue of questions and answers occurring after said issue is presented by said user,
said specialized telephone device automatically identifying a topic presented during said verbal telephone call, said identifying a topic comprising analyzing said input to select said topic from a plurality of previously established topics,
said specialized telephone device automatically selecting a commercial opportunity relating to said topic based on previously established relationships between commercial opportunities and topics,
said graphic user interface automatically instructing said human call center representative to verbally provide said commercial opportunity to said user at a time within said verbal telephone call when said interactive dialogue of questions and answers indicates that a call situation matches said topic to said commercial opportunity and before terminating said verbal telephone call,
said graphic user interface receiving feedback from said human call center representative after said verbal telephone call is completed, and
said specialized telephone device revising said previously established relationships between commercial opportunities and topics based on said feedback.

17-18. (canceled)

19. The call center system according to claim 16, said graphic user interface:
providing feedback options on said graphic user interface; and
receiving input from said human call center representative into said feedback options.

20. The call center system according to claim 16, said specialized telephone device revising said previously established relationships by limiting commercial opportunities to specific topics.
